(19) United States
(12) Patent Application Publication
(10) Pub. No.: US 2009/0226072 A1
(43) Pub. Date: Sep. 10, 2009

(54) Operator methods for a centralized keying and balancing site and a number of remote image-based check processing sites

(75) Inventors: James M. Rossignoli, Cambridge (CA); David Gregg Simmons, Waterloo (CA); Susan H. Schott, Waterloo (CA); Graham Russell, Cambridge (CA)

Correspondence Address: MICHAEL CHAN;NCR CORPORATION, 1700 SOUTH PATTERSON BLVD, DAYTON, OH, 45479-0001, US

(73) Assignee: NCR Corporation

(21) Appl. No.: 12/074,955

(22) Filed: Mar. 7, 2008

(51) Int. Cl. G06K 9/00

(52) U.S. Cl. 382/138

(57) ABSTRACT

A method is provided of an operator at one of a plurality of remote image capture sites which provide units of work to be processed by an operator at a centralized keying and balancing site which is remote image capture site image capture site. The method of the operator at the one remote image capture site comprises receiving a unit of work which has been flagged by the operator processing the unit of work at the centralized keying and balancing site, retrieving at least one physical check based upon the unit of work which has been flagged by the operator processing the unit of work at the centralized keying and balancing site, and making a correction to the unit of work based upon the retrieved physical check

### BACKGROUND

The present invention relates to check processing, and is particularly directed to operator methods for a centralized keying and balancing site and a number of remote image-based check processing sites.

A typical image-based check processing site includes a check processing transport which has a document track and a number of check processing modules positioned along the document track for performing specific document processing operations on document items including checks moving downstream along the document track. A transport processor executes a transport application program which is stored in memory to control operation of devices contained within the check processing modules positioned along the document track and thereby to control operation of the check processing transport.

A typical check processing transport includes a hopper into which a stack of document items is placed. An operator initially prepares the document items (e.g., orienting document items properly (forwards and right-side up), removing staples, removing paper clips, straightening bent corners, and the like) before they are placed into the hopper. A document feeder adjacent the hopper selectively feeds or drives each document item from the stack of document items in the hopper to transport the document item from the upstream end to the downstream end along the document track past an image capture device and a magnetic ink character recognition (MICR) reader. The image capture device captures an image of the front of the document item and an image of the back of the document item. The MICR reader reads a codeline from each document item. The document items are eventually transported to sorting pockets of a pocket device located at the downstream end of the document track. The pockets receive document items which have been sorted based upon the particular transport application program.

At known image-based check processing sites, operators working at a keying and balancing workstation perform the functions of amount keying, codeline completion, balancing, and expert balancing. The three functions of amount keying, codeline completion, and balancing do not require an operator to have access to the physical checks which have been processed through the check processing transport. These operators perform these three functions using images of the document items. However, the function of expert balancing requires an operator to have access to the physical checks which have been processed through the check processing transport.

The keying and balancing workstation at known image-based check processing sites is located at the same location as the check processing transport. However, at some known image-based check processing sites, the three functions of amount keying, codeline completion, and balancing are located at a site remote from location of the check processing transport. Since the function of expert balancing requires operator-access to physical checks at the check processing transport, this function remains at the location of the check processing transport.

There has been a trend in financial institutions, such as large banks, moving their operations staff to a centralized site. The operations staff at the centralized site handles the three functions of amount keying, codeline completion, and balancing for a multiple number of check processing transports at different locations. It would be desirable for these financial institutions to also be able to move the expert balancing function, or at least a portion of it, to the centralized site.

### SUMMARY

In accordance with one embodiment of the present invention, a method is provided of an operator at one of a plurality of remote image capture sites. The one remote image capture site provides units of work to be processed by an operator at a centralized keying and balancing site which is remote from the one remote image capture site. The method of the operator at the one remote image capture site comprises receiving a unit of work which has been flagged by the operator processing the unit of work at the centralized keying and balancing site, retrieving at least one physical check based upon the unit of work which has been flagged by the operator processing the unit of work at the centralized keying and balancing site, and making a correction to the unit of work based upon the retrieved physical check.

### BRIEF DESCRIPTION OF THE DRAWINGS

In the accompanying drawings:

FIG. 1 is a schematic block representation of a centralized keying and balancing site and a number of remote image-based check processing sites in accordance with one embodiment of the present invention;

FIG. 2 is a detailed schematic block representation of a check processing transport located at one of the remote image-based check processing sites shown in FIG. 1;

FIG. 3 is a detailed view of different types of pockets of a pocket device shown in the check processing transport shown in FIG. 2;

FIG. 4 is a flowchart depicting steps taken by an operator located at the centralized keying and balancing site shown in FIG. 1;

FIG. 5 is a flowchart depicting steps taken by an operator located at one of the plurality of remote image-based check processing sites shown in FIG. 1 after steps shown in the flowchart of FIG. 4 have been taken; and

FIG. 6 is a flowchart depicting further steps taken by an operator located at the centralized keying and balancing site shown in FIG. 1 after the steps shown in the flowchart of FIG. 5 have been taken.

### DETAILED DESCRIPTION

The present invention is directed to operator methods for a centralized keying and balancing site and a number of remote image-based check processing sites.

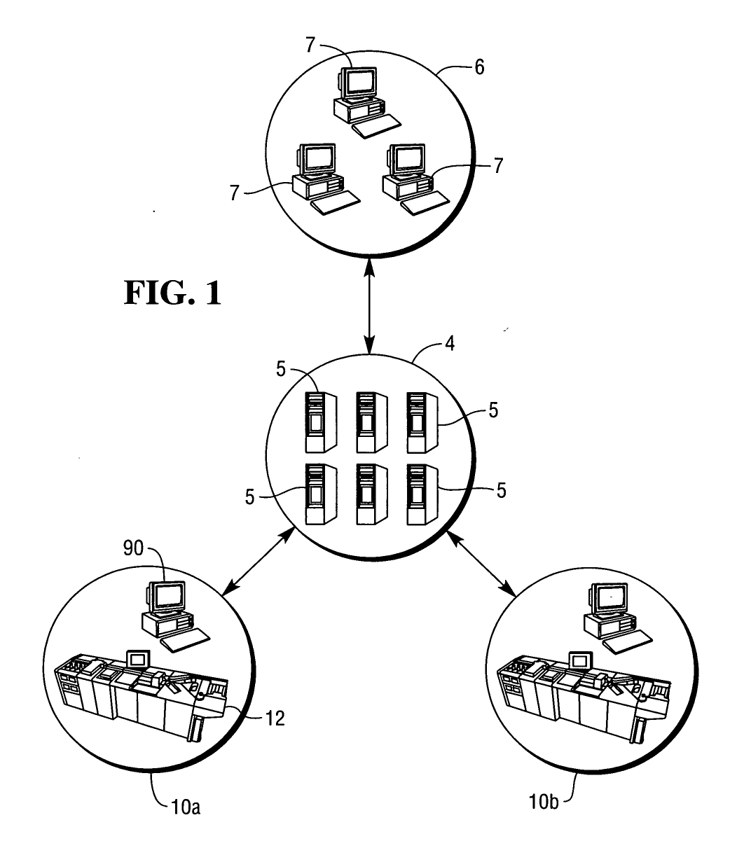

Referring to FIG. 1, each of a plurality of remote image capture sites 10a, 10b is located remotely from a data center site 4 and a centralized keying and balancing site 6. Although only two remote image capture sites (i.e., 10a and 10b) are shown in FIG. 1, it is conceivable that there could be any number more than two sites. The remote image capture sites 10a, 10b are similar. For simplicity, only the remote image capture site 10a will be described. An image-based check processing transport 12 is located at the site 10a. Also, a “physical repair/completion (PRC)” terminal 90 is located at the site 10a. Functionality and operation of the PRC terminal 90 will be described in detail later.

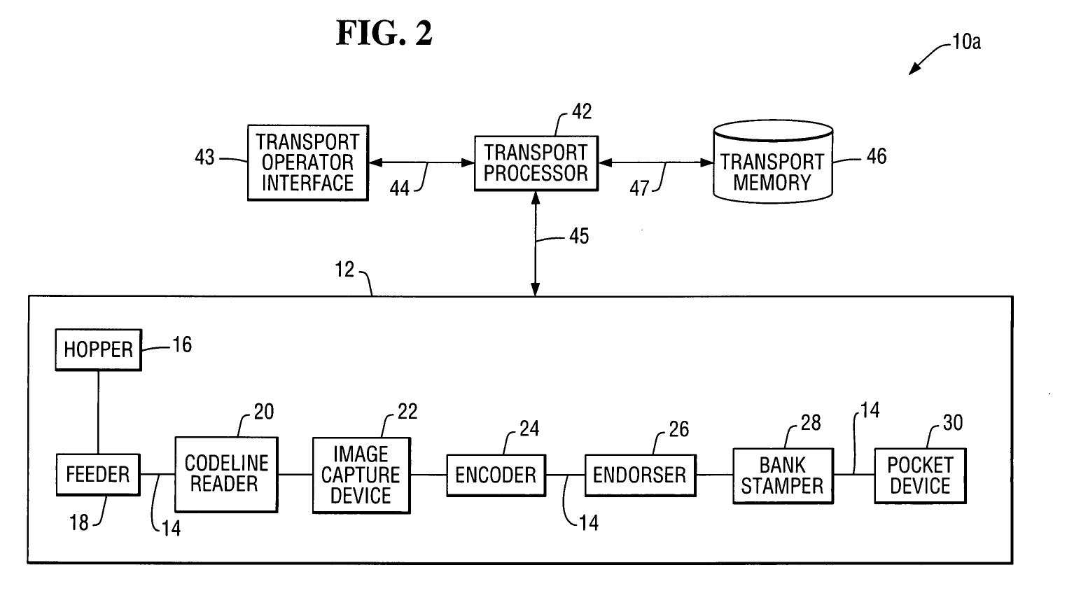

Referring to FIG. 2, a detailed schematic block representation of the check processing transport 12 located at the site 10a is illustrated. The specific construction and use of check processing transport 12 may vary. The check processing transport 12 may be, for example, a sorting machine or a proof machine wherein financial document items are processed in a bank. The financial document items may be in any number of forms. For example, a financial document item may be in the form of a check, a deposit slip, a cash-in slip, or a cash-out slip.

The check processing transport 12 has a document track 14 along which financial document items, such as checks, can be transported from an upstream end to a downstream end. The transport 12 includes a number of different check processing modules positioned along the document track 14. Each check processing module includes a number of devices associated with the particular check processing module for performing specific document processing operations on document items moving along the document track. The transport 12 includes a hopper 16 into which a stack of financial document items including checks are placed. A document feeder 18 adjacent the hopper 16 selectively feeds or drives each document item from the stack of document items in the hopper to transport the document item from the upstream end to the downstream end along the document track 14.

A codeline reader 20, such as a magnetic ink character recognition (MICR) reader, is located along the document track 14. The MICR reader 20 reads a MICR codeline from each check being processed in a known manner. Alternatively, the codeline reader may be an OCR reader instead of a MICR reader depending upon the particular application. An image capture device 22 is located along the document track 14. The image capture device 22 captures images of the front and rear of each document item for a number of different purposes well known in the financial industry. More specifically, the image capture device 22 includes a front imaging camera and a rear imaging camera (both not shown) which are controlled to capture images of document items moving along the document track 14. The structure and operation of MICR readers, OCR readers, and imaging cameras are well known and, therefore, will not be described.

The check processing transport 12 may optionally include an encoder 24, an endorser 26, or a bank stamper 28, as shown in FIG. 2. The encoder 24 encodes missing fields on each check. The endorser 26 applies an endorsement in a known manner to each check. The bank stamper 28 stamps each check to identify the bank institution processing the check. The structure and operation of encoders, endorsers, and bank stampers are well known and, therefore, will not be described. Processed checks are then directed along the document track 14 to a pocket device 30.

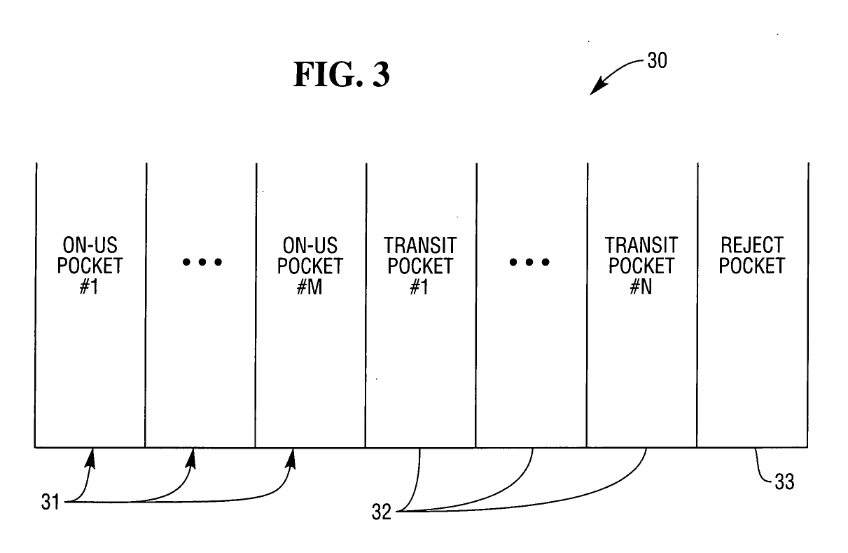

Referring to FIGS. 2 and 3, the pocket device 30 includes a number of different types of pockets into which document items are pocketed. As an example, three types of pockets are shown in FIG. 3. The three types of pockets include on-us pockets 31, transit pockets 32, and a reject pocket 33. By way of example, there are “M” number of on-us pockets, and “N” number of transit pockets shown in FIG. 3. The structure and operation of the pockets 31, 32, 33 in the pocket device 30 are well known and, therefore, will not be described. Also, the functionality of the on-us pockets 31, the transit pockets 32, and the reject pocket 33 is well known and, therefore, will not be described.

Referring again to FIG. 2, a transport operator interface 43 communicates via signals on line 44 with a transport processor 42. An operator interface 43 may include a keyboard, a mouse, and a display, all of which communicate via signals with the transport processor 42. The transport processor 42 controls operation of the transport 12 via signals on line 45. Suitable processors and memories are readily available in the marketplace. Their structure and operation are well known and, therefore, will not be described.

A transport memory 46 communicates via signals on line 47 with the transport processor 42. The memory 46 may comprise a single memory unit or a plurality of different memory units. An executable transport application program is stored in the memory 46. The transport application program is associated with a particular type of document processing work. For example, one type of work is proof of deposit. Another type of work is remittance processing. Still another type of work may be sorting of document items.

When the transport application program is executed, the devices contained within the check processing modules lying along the document track 14 are controlled to process document items moving downstream along the document track in accordance with the transport application program, as is known. The memory 46 may store sequence numbers, MICR codelines, and image data associated with document items which have been processed in accordance with the transport application program. If applicable, the memory 46 may also store encoder status, endorsement status, or bank stamp status.

Data stored in the memory 46 is also transmitted to and stored on a number of servers 5 located at the data center site 4, as shown in FIG. 1. Operators working on image display terminals (IDTs) 7 located at the centralized keying and balancing site 6 can access the data stored on the servers 5 located at the data center site 4. The operators working at the IDTs 7 perform known keying and balancing functions. These known functions include (i) amount keying in which an operator manually completes the amount of debit items and credit items, (ii) codeline completion in which an operator manually completes a MICR codeline which identifies a particular transaction item, and (iii) balancing in which an operator balances out-of-proof transactions.

In accordance with one embodiment of the present invention, an operator working at one of the IDTs 7 located at the centralized keying and balancing site 6 also performs another function which comprises at least a portion of the function of expert balancing. In known systems, the function of expert balancing is performed entirely at the remote image capture site 10a. In this embodiment of the present invention, the operator working at the one of the IDTs 7 located at the centralized keying and balancing site 6 performs at least a portion of the function of expert balancing, and another operator working at the PRC terminal 90 located at the data center site 4 performs other portions of the function of expert balancing. Accordingly, both operators co-operate to perform the function of expert balancing.

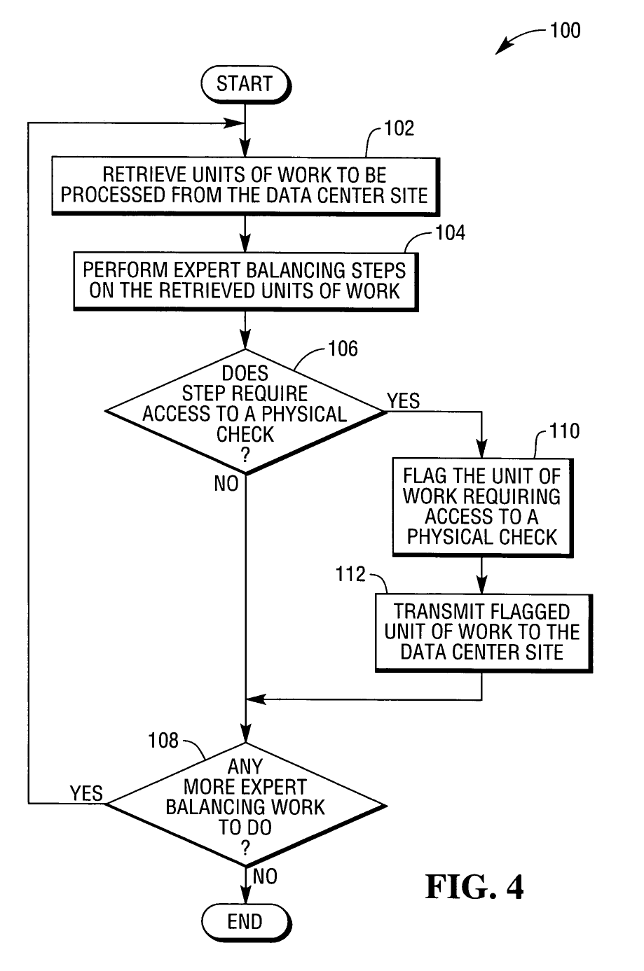

Referring to FIG. 4, a flowchart 100 depicts steps taken by an operator working at the centralized keying and balancing site 6. The operator retrieves units of work to be processed from servers 5 at the data center site 4 (step 102). These units of work have been previously transmitted from the remote image capture site 10a to the servers 5 as previously described hereinabove. The operator performs at least some expert balancing steps on the retrieved units of work (step 104).

The operator then makes a determination as to whether access to a physical check is required to complete the expert balancing function (step 106). If the determination in step 106 is negative (i.e., no access to a physical check is required), then the process proceeds to step 108. A determination is made in step 108 as to whether there is more expert balancing work for the operator at the centralized keying and balancing site 6 to be performed. If the determination in step 108 is affirmative (i.e., there is more work to perform), then the process returns back to step 102 for the operator to retrieve more expert balancing work to do. Otherwise, the process terminates.

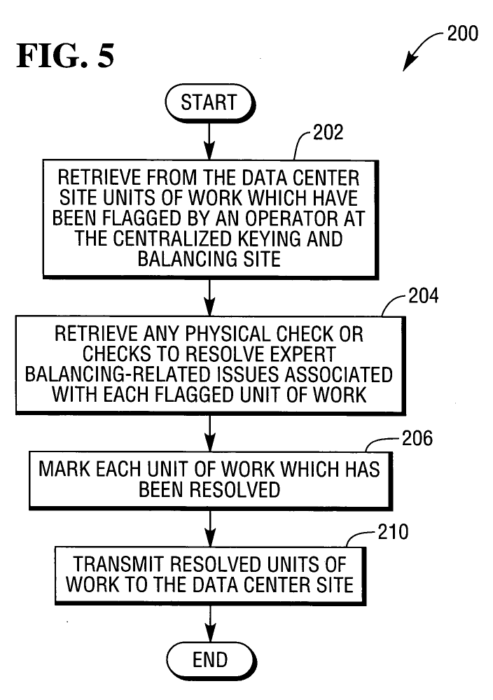

However, if the determination back in step 106 is affirmative (i.e., access to at least one physical check is required), then the process proceeds to step 110 to flag the unit of work as needing access to a physical check to complete expert balancing. After the unit of work has been flagged, the process proceeds to step 112 in which the flagged unit of work is transmitted to the data center site 4 to store the flagged unit of work at the servers 5. These flagged units of work stored at the servers can be accessed by an operator working at the remote image capture site 10a for the purpose of resolving expert balancing issues associated with these flagged units of work, as will be described hereinbelow in the flowchart of FIG. 5.

After the flagged units of work have been transmitted to the servers 5 at the data center site 4, the process then proceeds to step 108 to make a determination as to whether there are more expert balancing work for the operator at the centralized keying and balancing site 6 to be performed. If the determination in step 108 is affirmative (i.e., there is more work to perform), then the process returns back to step 102 to retrieve more expert balancing work to do. Otherwise, the process terminates.

Referring to FIG. 5, a flowchart 200 depicts steps taken by the operator working at the remote image capture site 10a. The operator retrieves from the servers 5 of the data center site 4 units of work which have been previously flagged by the operator at the centralized keying and balancing site 6 (step 202). The operator then retrieves any physical checks or checks as needed to resolve expert balancing related issues in connection with each flagged unit of work (step 204).

The operator working at the remote image capture site 10a may make corrections to resolve expert balancing related issues. As an example, the operator may need to rescan a physical check to reimage the check to resolve an issue. As another example, the operator may need to inspect physical checks for a piggyback condition. Still as another example, the operator may need to look at a physical check because certain colors (usually light colors) which are unable to be image lifted.

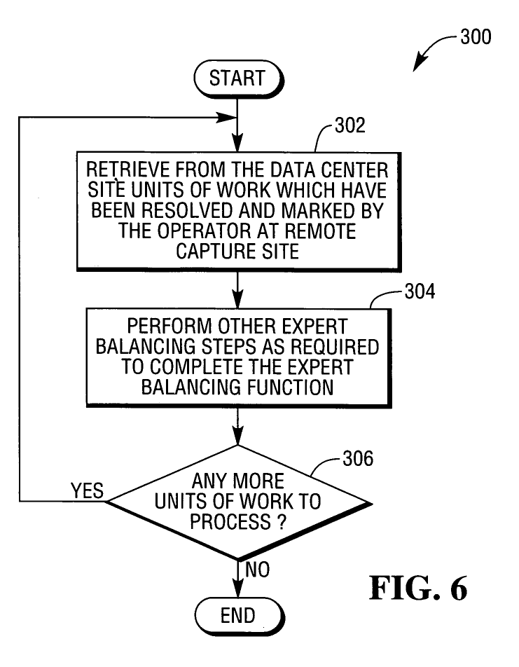

The operator at the remote image capture site 10a marks each unit of work which has been resolved back in step 204 to identify these units of work as having been resolved (step 206). The operator then transmits these marked units of work back to the servers 5 of the data center site 4 (step 210). These marked units of work stored at the servers 5 can be accessed by the operator working at the centralized keying and balancing site 6 for the purpose of performing further expert balancing steps to complete the expert balancing function on these marked units of work, as will be described hereinbelow in the flowchart of FIG. 6.

Referring to FIG. 6, a flowchart 300 depicts further steps taken by the operator working at the centralized keying and balancing site 6 after the operator working at the remote image capture site 10a has performed the steps shown in the flowchart of FIG. 5. The operator retrieves from the servers 5 at the data center site 4 units of work which have been previously resolved and marked by the operator at the remote image capture site 10a (step 302). The operator then performs other expert balancing steps as required for these marked units of work to complete the expert balancing function on the marked units of work (step 304).

After the expert balancing function has been completed, a determination is made in step 306 as to whether there are any more units of work to be processed. If the determination in step is affirmative (i.e., there are more units of work to be processed), then the process returns back to 302 to allow the operator at the remote image capture site 10a to retrieve other units of work. However, if the determination in step 306 is negative (i.e., there are no more units of work to be processed), then the process terminates.

It should be apparent that the expert balancing function has been divided between an operator working at the centralized keying and balancing site 6 and another operator working at the remote capture site 10a. Both operators co-operate to perform and complete the expert balancing function which was previously performed by only operators located at the remote capture site 10a. Examples of expert balancing situations which require the operator at the remote capture site 10a to have access to the physical checks include the following: (i) a need to see information which is not available on a check image (e.g., a check written in light colored ink), (ii) a need to moved check items from one physical tray to another physical tray, (iii) a need to resolve piggybacked items, (iv) a need to physically rescan a check, and (v) a need to obtain additional information which may not be available at the centralized site 6 (e.g., full page listings or adding machine tapes not scanned with checks).

Although the above description describes the remote image capture site 10a as comprising the image-based check processing transport 12, it is conceivable the site may comprise a device other than a check processing transport. The device may comprise any type of device with check image lift capability. As an example, the device may comprise a check image lift device located at an automated teller machine (ATM). As another example, the device may comprise a check image lift device located at a branch of a bank. Still as another example, the device may comprise an electronic device which captures check images and provides electronic image files in a predefined format such as an X9.37 standards file.

Also, although the above description describes the operator at the centralized keying and balancing site 6 manually flagging units of work, it is conceivable that units of work may be automatically flagged instead of manually flagged. As an example, a reimage request could be automatically generated for a particular item which is being processed. As a result of the reimage request being generated, the particular item would be flagged and subsequently transmitted to the data center site 4. Moreover, it is conceivable that all steps performed by the operator at the centralized keying and balancing site 6 and all steps performed at the remote image capture site 10a (except for the manual steps of the operator retrieving a number of physical checks and making subsequent corrections) may be performed automatically without human intervention.

Further, although the above description describes one of the operators working at the IDTs 7 located at the centralized keying and balancing site 6 performing a portion of the expert balancing function, it is conceivable that more than one of the operators perform this function. It is also conceivable that the one or more operators working at the IDTs 7 may be dedicated to only performing only at least some portion of the expert balancing function and not any other function.

It should also be noted that the data center site 4 and the centralized keying and balancing site 6 are usually located remote from each other. However, it is conceivable that the sites 4, 6 are at the same location.

The particular arrangements disclosed are meant to be illustrative only and not limiting as to the scope of the invention. From the above description, those skilled in the art to which the present invention relates will perceive improvements, changes and modifications. Numerous substitutions and modifications can be undertaken without departing from the true spirit and scope of the invention. Such improvements, changes and modifications within the skill of the art to which the present invention relates are intended to be covered by the appended claims.

What is claimed is:

1. A method of an operator at one of a plurality of remote image capture sites which provide units of work to be processed by an operator at a centralized keying and balancing site which is remote from the one of the remote image capture sites, the method comprising:
receiving a unit of work which has been flagged by the operator processing the unit of work at the centralized keying and balancing site;
retrieving at least one physical check based upon the unit of work which has been flagged by the operator processing the unit of work at the centralized keying and balancing site; and
making a correction to the unit of work based upon the retrieved physical check.

2. A method according to claim 1, further comprising:
transmitting to a data center site information associated with the correction made to the unit of work to allow the operator at the centralized keying and balancing site to retrieve the information from the data center site to complete expert balancing.

3. A method according to claim 1, wherein the operator at the remote image capture site and the operator at the centralized keying and balancing site co-operate to perform an expert balancing function.

4. A method according to claim 1, wherein each of the plurality of remote image capture sites comprises a check processing transport.

5. A method of an operator located at a centralized keying and balancing site which processes units of work from a plurality of remote image capture sites, the method comprising:
receiving units of work from each of the plurality of remote image capture sites;
identifying at least one unit of work which requires physical access to a check located at the one remote image capture site;
flagging the identified unit of work which requires access to a check located at the one remote image capture site;
transmitting the flagged unit of work to the one remote image capture site to allow an operator located at the one remote image capture site to retrieve a physical check associated with the flagged unit of work and make a correction associated with the retrieved physical check; and
receiving from the operator located at the one remote image capture site a signal which is indicative of the correction having been made to the retrieved physical check so that the flagged unit of work can be further processed at the centralized keying and balancing site.

6. A method according to claim 5, further comprising:
performing at least one of the functions of amount keying, codeline completion, and balancing for a unit of work received from one of the plurality of remote image capture sites.

7. A method according to claim 6, wherein the operator located at the centralized keying and balancing site co-operates with the operator located at the one remote image capture site to perform an expert balancing function.

8. A method according to claim 5, wherein each of the plurality of remote image capture sites comprises a check processing transport.

9. A method of operating a centralized keying and balancing site and a number of remote image capture sites, the method comprising:
an operator at the centralized keying and balancing site receiving units of work from each of the remote image capture sites;
the operator at the centralized keying and balancing site identifying at least one unit of work which requires physical access to a check located at one of the remote image capture sites;
the operator at the centralized keying and balancing site flagging the identified unit of work which requires access to a check located at the one remote image capture site;
the operator at the centralized keying and balancing site transmitting the flagged unit of work to the one remote image capture site to allow an operator located at the one remote image capture site to retrieve a physical check associated with the flagged unit of work and make a correction associated with the retrieved physical check;
the operator at the one remote image capture site receiving the unit of work which has been flagged by the operator at the centralized keying and balancing site;
the operator at the one remote image capture site retrieving at least one physical check based upon the unit of work which has been flagged by the operator at the centralized keying and balancing site; and
the operator at the one remote image capture site making a correction to the flagged unit of work based upon the retrieved physical check; and
the operator at the centralized keying and balancing site receiving a signal which is indicative of the correction having been made to the retrieved physical check so that the flagged unit of work can be further processed at the centralized keying and balancing site.

10. A method according to claim 9, wherein the operator located at the centralized keying and balancing site and the operator located at the one remote image capture site co-operate together to perform an expert balancing function.
